(19) United States
(12) Patent Application Publication
(10) Pub. No.: US 2025/0081032 A1
(43) Pub. Date: Mar. 6, 2025

(54) CONGESTION CONTROL IN A WIRELESS NETWORK

(71) Applicant: T-Mobile Innovations LLC, Overland Park, KS (US)

(72) Inventors: Zheng CAI, Fairfax, VA (US); Zheng FANG, McLean, VA (US)

(21) Appl. No.: 18/461,650

(22) Filed: Sep. 6, 2023

(51) Int. Cl. H04W 28/02

(52) U.S. Cl. CPC H04W 28/0289

(57) ABSTRACT

Systems and methods are provided for communicating multiple data packet types between user equipment (UE) and a single application, such as an extended reality application. The wireless network is configured such that each data packet type is communicated via a different wireless network slice. When notification of congestion in the wireless network is received for one or more of the wireless network slices, different congestion control algorithms are applied to the congested wireless network slices.

### TECHNICAL BACKGROUND

A wireless network, such as a cellular network, can include an access node (e.g., wireless access node) serving multiple wireless devices or user equipment (UE) in a geographical area covered by a radio frequency transmission provided by the access node. Access nodes may deploy different carriers within the cellular network utilizing different types of radio access technologies (RATs). RATs can include, for example, 3G RATs (e.g., GSM, CDMA etc.), 4G RATs (e.g., WiMax, LTE, etc.), and 5G RATs (new radio (NR)).

Further, different types of access nodes may be implemented for deployment for the various RATs. For example, a next generation NodeB (gNodeB or gNB) may be utilized for 5G RATs. Deployment of the evolving RATs in a network provides numerous benefits. For example, newer RATs may provide additional resources to subscribers, faster communications speeds, and other advantages.

Although 5G RATs boost network capacity and communication speeds, the 5G RATS can become congested and experience packet loss as applications require more bandwidth and speed for communicating data.

### OVERVIEW

One aspect of the present disclosure relates to a system configured for congestion control in a wireless network. The system may include one or more hardware processors configured by machine-readable instructions. The processor(s) may be configured to communicate first data packet types from a single application to a UE using a first wireless network slice for a first RAN. The processor(s) may be configured to communicate second data packet types from the single application to the UE using a second wireless network slice for a second RAN. The processor(s) may be configured to receive a first notification of wireless network congestion for the first wireless network slice. The processor(s) may be configured to apply a first congestion control algorithm to the first wireless network slice. The processor(s) may be configured to receive a second notification of wireless network congestion for the second wireless network slice. The processor(s) may be configured to apply a second congestion control algorithm to the second wireless network slice.

In some implementations of the system, the first RAN may be different from the second RAN. In some implementations of the system, the first RAN and the second RAN may be new radio access networks.

In some implementations of the system, the first notification of wireless network congestion may indicate a congestion control threshold has been satisfied for the first data packet types. In some implementations of the system, the second notification of wireless network congestion may indicate a congestion control threshold has been satisfied for the second data packet types.

In some implementations of the system, the first congestion control algorithm may be different from the second congestion control algorithm.

In some implementations of the system, the first congestion control algorithm may be one of DCTCP, TCP Prague, an L4S variant of the RMCAT SCReAM controller and the L4S ECN part of BBRv2 intended for TCP and QUIC Transport.

Another aspect of the present disclosure relates to a method for congestion control in a wireless network. The method may include communicating first data packet types from a single application to a UE using a first wireless network slice for a first RAN. The method may include communicating second data packet types from the single application to the UE using a second wireless network slice for a second RAN. The method may include receiving a first notification of wireless network congestion for the first wireless network slice. The method may include applying a first congestion control algorithm to the first wireless network slice. The method may include receiving a second notification of wireless network congestion for the second wireless network slice. The method may include applying a second congestion control algorithm to the second wireless network slice.

Yet another aspect of the present disclosure relates to a non-transient computer-readable storage medium having instructions embodied thereon, the instructions being executable by one or more processors to perform a method for congestion control in a wireless network. The method may include communicating first data packet types from a single application to a UE using a first wireless network slice for a first RAN. The method may include communicating second data packet types from the single application to the UE using a second wireless network slice for a second RAN. The method may include receiving a first notification of wireless network congestion for the first wireless network slice. The method may include applying a first congestion control algorithm to the first wireless network slice. The method may include receiving a second notification of wireless network congestion for the second wireless network slice. The method may include applying a second congestion control algorithm to the second wireless network slice.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operations. In the drawings:

FIG. 1 depicts a wireless network that may be connected to a host server and mobile device, in accordance with disclosed examples.

FIG. 2 illustrates a system and a congestion control engine engine, in accordance with the disclosed examples.

FIG. 3 illustrates a method for congestion control in a wireless network, in accordance with disclosed examples.

FIG. 4 illustrates a method for configuring a wireless network, in accordance with disclosed examples.

FIG. 5 illustrates an IP Header, in accordance with disclosed examples.

FIG. 6 illustrates a TCP Header, in accordance with disclosed examples.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In addition to the particular systems and methods described herein, the operations described herein may be implemented as computer-readable instructions or methods, and a processor on the network for executing the instructions or methods. The processor may include an electronic processor.

Existing wireless networks can become overloaded with data packets causing queueing, delay, and packet drop which negatively affect network performance. Current network configurations allow more traffic to enter the wireless network than the network can handle. In a wireless network, a 5G gNB can be a bottleneck in terms of latency and capacity. Conventionally, TCP/IP in wireless networks signal congestion by dropping packets.

To improve utilization of 5G resources, as an example, multiple congestion control algorithms may be used for the same application. For example, multiple network slices may be configured in the wireless network to communicate data packets between the same application and user equipment (UE). Using configuration profiles, multiple logical network slices are configured for different data packet types for communication between the same application and the UE. The network slice profiles may be configured using Low Latency Low Loss Scalable Throughput (L4S). L4S improves network latency and packet loss by applying optimized congestion control (CC) algorithms for time critical applications.

When multiple slices are configured for the same application using L4S, network slice RANs may be used for different data packet types and different congestion control algorithms may be applied to different data packet types. Multiple L4S network slice profiles may be configured in the wireless network for different data packet types. Exemplary RANs may include new radio access networks such as 5G URLCC, 5G eMBB, and 5G MTTC. It is costly to deploy some 5G radio access network (RAN), such as 5G URLLC, features all over the wireless network. As such, it is beneficial to separate critical content data packet types from less critical content data packet types.

For example, when the application is XR or a gaming application, I-frames for video have critical content for the application and are critical data packet types. As I-frames are critical data packet types, a network slice for 5G URLLC is configured for communication of I-frame data packets for extended reality (XR) or gaming application. An I-frame (Intra-coded picture), a complete image, like a JPG or BMP image file. The I-frame is the reference frame in terms of video encoding, used by inter-frame compression algorithms to encode other frames, such as P and B frames. P and B frames hold only part of the image information, such as the part that changes between frames, so they need less space and are not as critical as an I-frame. P-frames can use data from previous frames to decompress and are more compressible than I-frames. B-frames can use both previous and forward frames for data reference and can be highly compressed as compared to I-frames.

Multiple L4S slice profiles allow a URLLC edge network to be utilized for the critical part of the XR content and the less costly eMBB network for less critical XR content. A network slice for 5G eMBB may be configured for less critical P/B frames of XR content.

Multiple L4S slice profiles also allow different congestion control algorithms to be applied to different data packet types to reach the best XR resource utilization, saving deployment cost for mobile network operators (MNO).

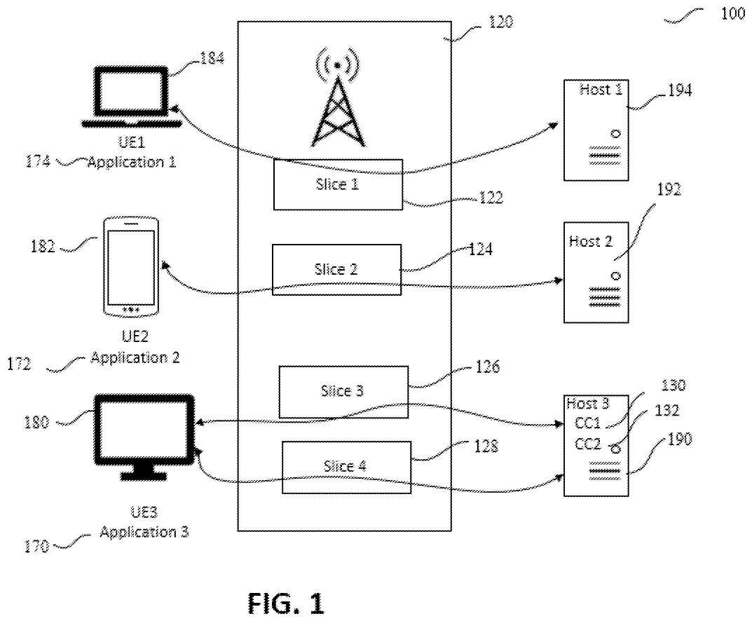

FIG. 1 depicts wireless environment 100 illustrating an access node 120 and UEs 180, 182 and 184 and host application servers 190, 192 and 194. The UE 180, 182, and 184 may be a cell phone, mobile phone, wireless phone, home wireless device, laptop, desktop, as well as other types of devices or systems that are capable of radio frequency communication. UEs 180, 182, and 184 are capable of attaching to access node 120. Access node 120 may be operated by a Mobile Network Operator (MNO). While the wireless environment, it may comprise multiple UEs, access nodes 120 and host application servers.

Access node 120 may be for a wireless network, such as a cellular network, and can include a core network and a radio access network (RAN) serving multiple UEs 180, 182 and 184 in a geographical area covered by a radio frequency transmission provided by the access network. As technology has evolved, different carriers (MNOs) within the cellular network may utilize different types of radio access technologies (RATs). RATs can include fifth generation (5G) RATs (new radio (NR)) and 6G. Further, different types of access nodes may be implemented within the access network for deployment for the various RATs. A next generation NodeB (gNB) may be utilized for 5G RATs. Deployment of the evolving RATs in a network provides numerous benefits. For example, newer RATs, such as 5G RATs, may provide additional resources to subscribers, faster communications speeds, and other advantages.

Host application servers 190, 192, and 194 generate dynamic content and may simulate an XR universe and/or game worlds. A host application server enables a server to generate a dynamic, customized response to a user request. In an example, a host application server may be a simulated environment such as extended reality (XR) server, a virtual reality server, an augmented reality server, and a game server. A host application server transmits data about its internal state to connected users to maintain an accurate version of the application. For example, a host application server may be the authoritative source of events in a multi-user or multi-client simulated environment. The host application server transmits enough data about its internal state to allow connected UEs 180, 182 and 184 to maintain their own accurate version of the simulated environment and process each player's input.

Extended reality (XR) is the overarching term for a spectrum of technologies that link or integrate the digital world and the real world. These include augmented reality (AR), mixed reality (MR), and virtual reality (VR) technologies, all of which provide different degrees of sensory immersion and interaction between the real world and digital content. XR may exist in a virtual universe or interconnected network of virtual and augmented realities.

Host application servers may contain web containers and logic containers, such as Enterprise Java Beans (EJB) containers. Host application servers are responsible for creating an environment for enterprise, XR, gaming and virtual applications. Host application servers may be capable of supporting HTTP as well as RPC/PMI protocols. Host application servers may provide the runtime environment and multi-threading for enterprise applications, XR environments and gaming environments.

With reference to FIG. 1, UEs 180, 182, and 184 connect with host application servers 190, 192, and 194 using separate applications 170, 172, and 174 in order to see and interact with a simulated universe or game world of host application servers 190, 192 and 194. Host application servers may be hosted in professional data centers for improved reliability.

Traditionally, host application servers 192 and 194 communicate via single network slices 122 and 124 respectively. For example, all types of data packets from host application server 194 travel through a single network slice 122.

UE 180 communicates with host application server 190 a wireless network via multiple network slices 126 and 128. Data packet types being communicated between UE 180 and host application server 190 may be separated into multiple network slices.

5G network slicing is a network architecture that enables the multiplexing of virtualized and independent logical networks on the same physical network infrastructure. For example, a 5G network may have multiple slices, for example Enhanced Mobile Broadband (eMBB), Massive Machine Type Communications (mMTC) and Ultra-Reliable Low Latency Communication (uRRLC). Each network slice may be an isolated end-to-end network tailored to fulfil diverse requirements requested by a particular application. A 5G slice may include dedicated radio, transport and core resources including a dedicated user plane function at the edge.

When, data packet types being communicated between host application server 190 and UE 180 are separated into multiple network slices, different congestion control algorithms (CC1 (130) and CC2 (132)) may be applied to different packet types. For example, when network congestion is detected, the CC1 algorithm is applied to data packets for I frames communicated via network slice 126 (URLCC). CC2 algorithm is applied to data packet types for P and B frames communicated via network slice 128 (eMBB).

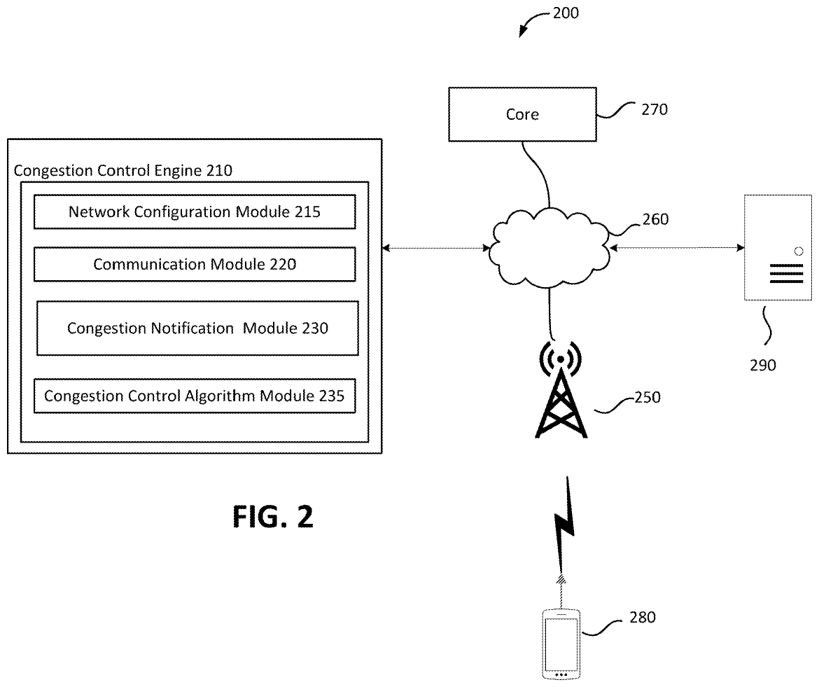

FIG. 2 illustrates a system 200 configured for routing data packets from a single application, in accordance with one or more implementations.

As illustrated, system 200 comprises routing engine 210, an access node 250, a network 260, a core 270, which provide service in a coverage area, a UE 280, and a host application server 290. For purposes of illustration and ease of explanation, only one access node 250, UE 280 and host application server 290 are shown in the system 200; however, as noted above with regard to FIG. 1, additional access nodes and/or application host servers and UEs may be present in the system 200.

In the illustration of FIG. 2, the access node 250 is connected to the network 260 via an NR path (including the 5G core 270); however, in practical implementations the access node 250 may be connected to network 260 via multiple paths (e.g., using multiple RATs). The access node 250 may communicate with the core 270 via one or more communication links, each of which may be a direct link. However, it will be appreciated that network 260 may be any type of network facilitating communication among routing engine 210, access node 250, host application server 290, core 270, and UE 280.

The access node 250 may be any network node configured to provide communications between the connected wireless devices. As examples of a standard access node, the access node 250 may be a gNodeB in 5G networks. Access node 250 and core 270 may also provide data to routing engine 210.

A routing engine 210 is in communication with the access node 250 and/or the core 270. Routing engine 210 may be configured for routing data packets from a single application.

The routing engine 210 can comprise one or more electronic processors and associated circuitry to execute or direct the execution of computer-readable instructions such as those described herein. In so doing, the routing engine 210 can retrieve and execute software from storage, which can include a disk drive, a flash drive, memory circuitry, or some other memory device, and which may be local or remotely accessible. The software may comprise computer programs, firmware, or some other form of machine-readable instructions, and may include an operating system, utilities, drivers, network interfaces, applications, or some other type of software, including combinations thereof. Moreover, the routing engine 210 can receive instructions and other input at a user interface.

As illustrated the routing engine 210 utilizes a modular controller, a memory, wireless communication circuitry, and a bus through which the various elements of the routing engine 210 may communicate with access node 250, core 270, and UE 280, host application server 290. The modular controller is one example of an electronic processor, and may include sub-modules or units, each of which may be implemented via dedicated hardware (e.g., circuitry), software modules which are loaded from the memory and processed by the controller, firmware, and the like, or combinations thereof.

The instruction modules may include one or more of network configuration module, communication module 220, congestion notification module 225, congestion control algorithm module 230, and/or other instruction modules. Some or all of the sub-modules or units may physically reside within the controller or may instead reside within the memory and/or may be provided as separate units, in any combination. The various sub-modules or units may include or implement logic circuits, thereby performing operations.

While FIG. 2 illustrates the network configuration module, communication module 220, congestion notification module 230, congestion control algorithm module 235, as being separate modules, in practical implementations some of the modules may be combined with one another and/or may share components. The network configuration module, communication module 220, congestion notification module 230, congestion control algorithm module 235, may be configured to perform various operations to implement methods in accordance with the present disclosure. While one example of operations performed by the modules is described here, in practical implementations at least some of the operations described as being performed by one module may instead be performed by another module, including a module not explicitly named here.

Configuration module 215 configures the network to transmit first data packet types between a single application and a UE using a first wireless network slice for a first RAN. Configuration module 215 configures the network to transmit second data packet types between the single application and the UE using a second wireless network slice for a second RAN. The first RAN and the second RAN may be new radio access networks such as 5G Enhanced Mobile Broadband (eMBB), 5G Massive Machine Type Communications (mMTC) and 5G Ultra-Reliable Low Latency Communication (uRRLC)

In one example, configuration network module configures the access node 250 such that communications between the host application server 290 and the UE 280 use multiple network slice RANs depending on the data packet type. The first RAN may be different from the second RAN. In examples, Low Latency, Low Loss, Scalable (L4S) is used to configure the multiple network slices.

L4s is an over-the-top method for rate adaptation between a UE 280 and a host application server 290. L4S has a large buffer to have enough time to react to changes in network conditions L4S enables low latency, high-rate communications with dynamic rate adaptation to a stable Quality of Experience (QoE), even when the wireless network is loaded. L4S provides real-time dynamic rate adaptation algorithms at the application layer for a stable QoE. L4S utilizes ECN (Explicit Congestion Notification), Dual Queue Coupled Active Queue Management (AQM), and scalable congestion control algorithms to reduce latency and packet loss. The congestion control algorithms may be optimized for wireless.

The first RAN may be a 5G eMBB network slice. A configuration profile for the access node 250, for instance in the gnodeB, may be set as URLLC L4S ECT for first data packet types. The second RAN may be a 5G URLLC network slice. A configuration profile in the access node, for instance in the gnodeB, may be set as URLLC L4S ECT for second data packet types.

After the 5G network slices are configured, communication module 220 communicates first data packet types between a UE 280 and host application server 290 using a first wireless network slice for a first RAN. The communication module 220 communicates second data packet types between the UE 280 and host application server 290 using a second wireless network slice for a second RAN. The single application may be an extended reality or gaming application.

Congestion notification module 230 may be configured to receive a first notification of wireless network congestion for the first wireless network slice. The first notification of wireless network congestion may indicate a congestion control threshold has been satisfied for the first data packet types. Congestion notification module 230 may be configured to receive a second notification of wireless network congestion for the second wireless network slice. The second notification of wireless network congestion may indicate a congestion control threshold has been satisfied for the second data packet types.

Classic TCP/IP networks signal congestion by dropping packets. ECN aware node sets up a marker in the IP header. A receiver sends a congestion indication to the sender who reduces its transmission rate.

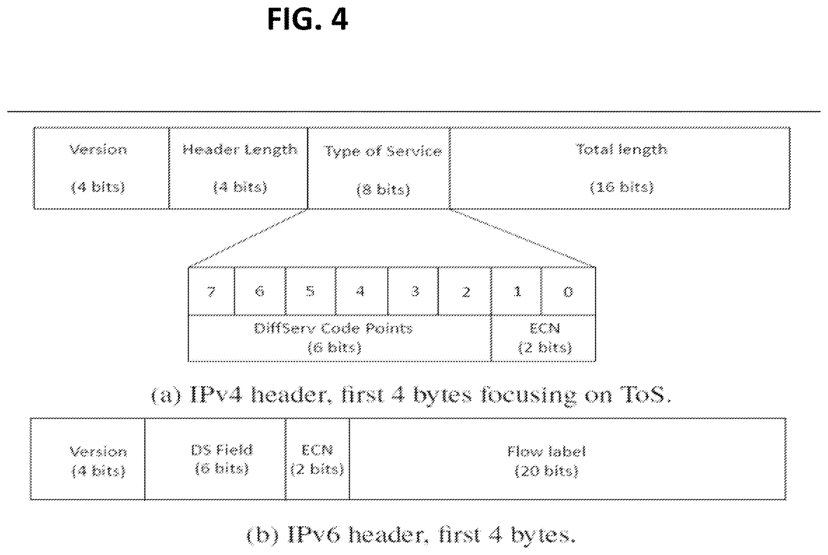

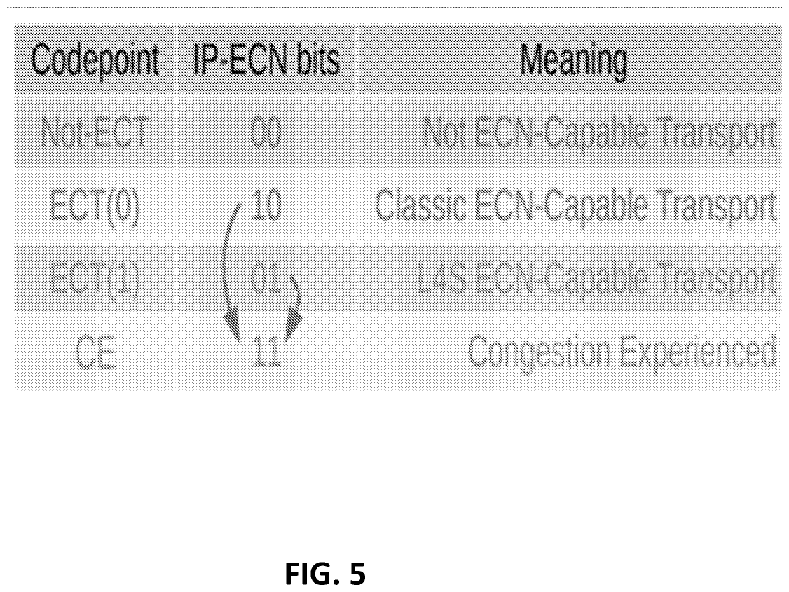

When using L4S configurations, as shown in FIG. 4 and FIG. 5, the ECT profile allows a host application server to distinguish L4S and classic traffic using an identifier of ECT (1) and CE codepoints of the ECN field. ECN is defined in RFC3168 (2001) which allows end-to-end (E2E) notification of network congestion without dropping packets.

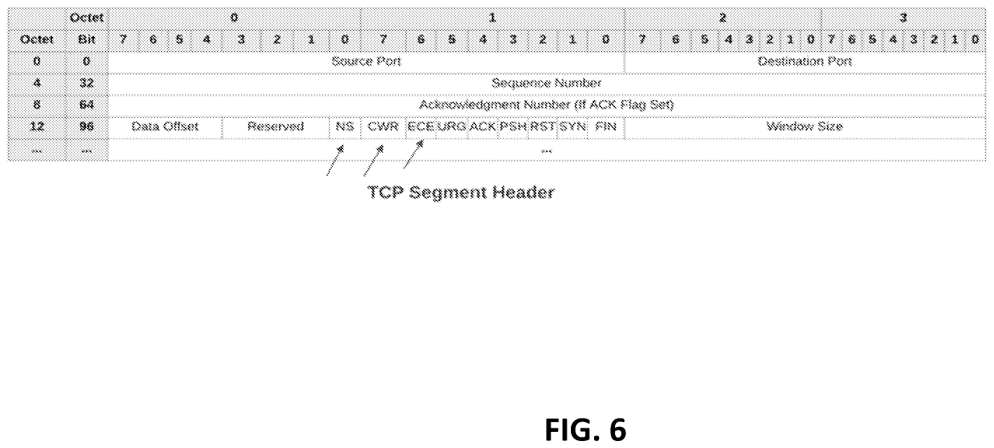

A congestion threshold being satisfied may also be identified in the header of TCP as shown in FIG. 6. Explicit Congestion Notification (ECN) in TCP includes ECE (Echo Congestion Experienced) CWR (Congestion Window Reduction) and NS (Nonce Sum). ECE is a flag in the TCP header that can be sent to indicate congestion. CWR is the flag in the TCP header that can be set and sent to indicate its reception of the ECE.

Congestion control algorithm module 235 may be configured to apply a first congestion control algorithm to the first wireless network slice. By way of non-limiting example, the first congestion control algorithm may be one of DCTCP, TCP Prague, an L4S variant of the RMCAT SCREAM controller and the L4S ECN part of BBRv2 intended for TCP and QUIC Transport.

Congestion control algorithm module 235 may be configured to apply a second congestion control algorithm to the second wireless network slice. The first congestion control algorithm may be different from the second congestion control algorithm. The second congestion control algorithm may be one of DCTCP, TCP Prague an L4S variant of the RMCAT SCREAM controller and the L4S ECN part of BBRv2 intended for TCP and QUIC Transport. The first wireless network slice and the second wireless network slice may be configured in the wireless network using L4S routing protocol. A routing protocol for the first wireless network slice may be an embb L4S ECN-Capable Transport ECT profile for the first data packet types.

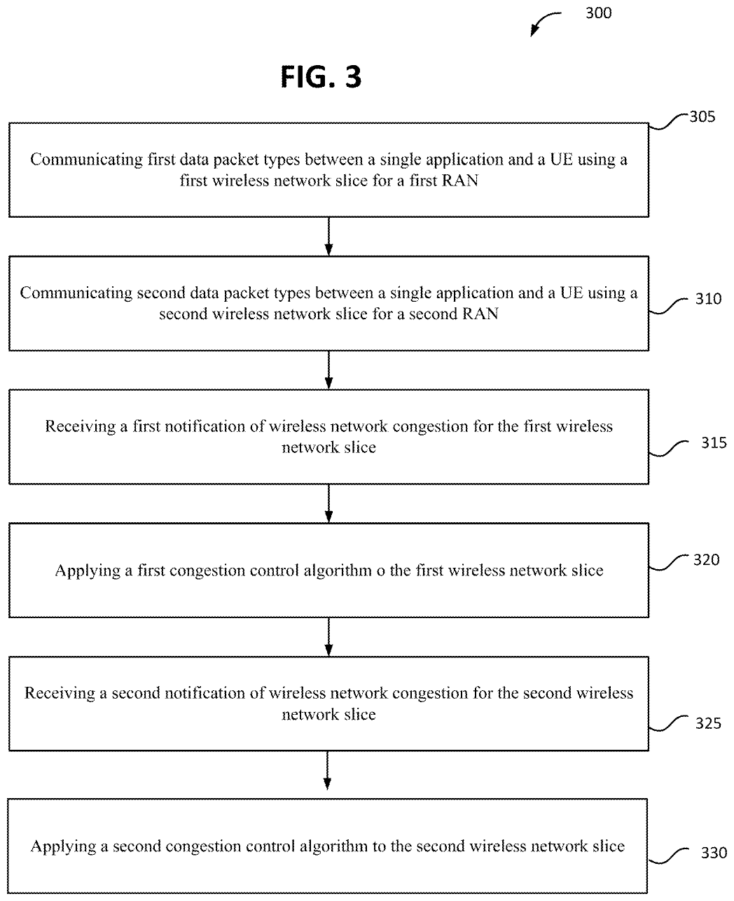

FIG. 3 illustrates an exemplary process flow for congestion control in a wireless network. The operations of FIG. 3 will be described as being performed by the congestion control engine 210 for purposes of explanation. In other implementations, the operations may be performed by or under the control of a processor of an application server, wireless access node, 5G core or processed in a cloud environment.

FIG. 3 illustrates a method 300 for congestion control in a wireless network, in accordance with one or more implementations. The operations of method 300 presented below are intended to be illustrative. In some implementations, method 300 may be accomplished with one or more additional operations not described, and/or without one or more of the operations discussed. Additionally, the order in which the operations of method 300 are illustrated in FIG. 3 and described below is not intended to be limiting.

In some implementations, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

The process flow begins at operation 305, when first data packet types are communicated between a single application and a UE using a first wireless network slice for a first RAN. At operation 310, second data packet types are communication from the single application to the UE using a second wireless network slice for a second RAN. The network is configured to transmit first data packet types between a single application and a UE using a first wireless network slice for a first RAN. The network is further configured to transmit second data packet types between the single application and the UE using a second wireless network slice for a second RAN. The first RAN and the second RAN may be new radio access networks such as 5G Enhanced Mobile Broadband (eMBB), 5G Massive Machine Type Communications (mMTC) and 5G Ultra-Reliable Low Latency Communication (uRRLC). It will be appreciated that there may be multiple slices (two or more) configured to transmit different data packet types.

At operation 315, a first notification of wireless network congestion is received for the first wireless network slice. At operation 320, a first congestion control algorithm is applied to the first wireless network slice. The congestion control algorithm may be one of DCTCP, TCP Prague an L4S variant of the RMCAT SCREAM controller and the L4S ECN part of BBRv2 intended for TCP and QUIC Transport. At operation 325, a second notification of wireless network congestion is received for the second wireless network slice. At operation 330, a second congestion control algorithm is applied to the second wireless network slice. The congestion control algorithm may be one of DCTCP, TCP Prague an L4S variant of the RMCAT SCREAM controller and the L4S ECN part of BBRv2 intended for TCP and QUIC Transport.

The operations of FIG. 3 need not necessarily be performed one after another in immediate sequence. While the above descriptions illustrate various aspects of the present disclosure, the present disclosure is not so limited. The methods and operations described above may be performed in an iterative matter. These additional iterations may also be reverted in a manner similar to that described above.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention and are intended to be illustrative and not restrictive. Many examples and applications other than the examples provided would be apparent to those skilled in the art upon reading the above description. The scope should be determined, not with reference to the above description, but instead with reference to the appended claims, along with the full scope of equivalents to which such claims are entitled. It is anticipated and intended that future developments will occur in the technologies discussed herein, and that the disclosed systems and methods will be incorporated into future examples. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, the use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system configured for congestion control in a wireless network, the system comprising:
one or more hardware processors configured by machine-readable instructions to:
communicate first data packet types between a single application and user equipment (UE) using a first wireless network slice for a first radio access network (RAN);
communicate second data packet types between the single application and the UE using a second wireless network slice for a second RAN;
receive a first notification of wireless network congestion for the first wireless network slice;
apply a first congestion control algorithm to the first wireless network slice;
receive a second notification of wireless network congestion for the second wireless network slice; and
apply a second congestion control algorithm to the second wireless network slice.

2. The system of claim 1, wherein the first RAN is different from the second RAN.

3. The system of claim 2, wherein the first RAN and the second RAN are new radio access networks.

4. The system of claim 1, wherein the first notification of wireless network congestion indicates a congestion control threshold has been satisfied for the first data packet types.

5. The system of claim 1, wherein the second notification of wireless network congestion indicates a congestion control threshold has been satisfied for the second data packet types.

6. The system of claim 1, wherein the first congestion control algorithm is different from the second congestion control algorithm.

7. The system of claim 6, wherein the first wireless network slice for the first RAN and the second wireless network slice are configured in a wireless network using Low Latency Low Loss Scalable Throughput (L4S) configuration profiles.

8. A method for congestion control in a wireless network, the method comprising:
communicating first data packet types from a single application to a UE using a first wireless network slice for a first RAN;
communicating second data packet types from the single application to the UE using a second wireless network slice for a second RAN;
receiving a first notification of wireless network congestion for the first wireless network slice;
applying a first congestion control algorithm to the first wireless network slice;
receiving a second notification of wireless network congestion for the second wireless network slice; and
applying a second congestion control algorithm to the second wireless network slice.

9. The method of claim 8, wherein the first RAN is different from the second RAN.

10. The method of claim 9, wherein the first RAN and the second RAN are new radio access networks.

11. The method of claim 8, wherein the first notification of wireless network congestion indicates a congestion control threshold has been satisfied for the first data packet types.

12. The method of claim 8, wherein the second notification of wireless network congestion indicates a congestion control threshold has been satisfied for the second data packet types.

13. The method of claim 8, wherein the first congestion control algorithm is different from the second congestion control algorithm.

14. The method of claim 13, wherein the first wireless network slice for the first RAN and the second wireless network slice are configured in the wireless network using Low Latency Low Loss Scalable Throughput (L4S) configuration profiles.

15. A non-transient computer-readable storage medium having instructions embodied thereon, the instructions being executable by one or more processors to perform a method for congestion control in a wireless network, the method comprising:
communicating first data packet types between a single application and user equipment (UE) using a first wireless network slice for a first RAN;
communicating second data packet types from the single application to the UE using a second wireless network slice for a second RAN;
receiving a first notification of wireless network congestion for the first wireless network slice;
applying a first congestion control algorithm to the first wireless network slice;
receiving a second notification of wireless network congestion for the second wireless network slice; and
applying a second congestion control algorithm to the second wireless network slice.

16. The computer-readable storage medium of claim 15, wherein the first RAN is different from the second RAN.

17. The computer-readable storage medium of claim 16, wherein the first RAN and the second RAN are new radio access networks.

18. The computer-readable storage medium of claim 15, wherein the first notification of wireless network congestion indicates a congestion control threshold has been satisfied for the first data packet types.

19. The computer-readable storage medium of claim 15, wherein the second notification of wireless network congestion indicates a congestion control threshold has been satisfied for the second data packet types.

20. The computer-readable storage medium of claim 15, wherein the first wireless network slice for the first RAN and the second wireless network slice are configured in the wireless network using Low Latency Low Loss Scalable Throughput (L4S) configuration profiles.
